(19) United States
(12) Patent Application Publication
(10) Pub. No.: US 2026/0235825 A1
(43) Pub. Date: Aug. 13, 2026

(54) OFFSET OPTICAL COUPLER CONFIGURATIONS FOR HIGH DENSITY FIBER COUPLING

(71) Applicant: Lightmatter, Inc., Mountain View, CA (US)

(72) Inventors: Omkar Karhade, Chandler, AZ (US); Shashank Gupta, Gurugram (IN); Sandeep Sane, Chandler, AZ (US); Sufi Ahmed, Chandler, AZ (US); Mitul Modi, Phoenix, AZ (US)

(73) Assignee: Lightmatter, Inc., Mountain View, CA (US)

(21) Appl. No.: 19/531,997

(22) Filed: Feb. 6, 2026

Related U.S. Application Data
(60) Provisional application No. 63/756,005, filed on Feb. 7, 2025.
(60) Provisional application No. 63/762,736, filed on Feb. 25, 2025.
(60) Provisional application No. 63/766,294, filed on Mar. 3, 2025.
(60) Provisional application No. 63/780,130, filed on Mar. 28, 2025.
(60) Provisional application No. 63/925,412, filed on Nov. 25, 2025.

(51) Int. Cl. G02B 6/42

(52) U.S. Cl. CPC G02B 6/4214; G02B 6/4251

(57) ABSTRACT

A photonic device includes a photonic integrated circuit (PIC) comprising a plurality of waveguides, an optical coupler array positioned near an edge of the PIC, and a plurality of optical fibers. The optical coupler array comprises a plurality of optical couplers. Each optical coupler of the optical coupler array defines an optical path coupling a respective waveguide of the plurality of waveguides to a respective optical fiber of the plurality of optical fibers. At least two optical couplers of the plurality of optical couplers are offset relative to each other, either in a first direction perpendicular to the waveguide plane or a second direction perpendicular to the edge of the PIC, or both.

### CROSS-REFERENCE TO RELATED APPLICATIONS

This application claims the benefit of U.S. Provisional Application Ser. No. 63/756,005, filed on Feb. 7, 2025, under Attorney Docket No. L0858.70112US01 and entitled “OPTICAL COUPLERS FOR OPTICAL DEVICES;” U.S. Provisional Application Ser. No. 63/762,736, filed on Feb. 25, 2025, under Attorney Docket No. L0858.70112US02 and entitled “MOLDED COLLIMATED LENS ARCHITECTURE FOR 3D OPTICAL PACKAGES;” U.S. Provisional Application Ser. No. 63/766,294, filed on Mar. 3,2025, under Attorney Docket No. L0858.70112US03 and entitled “EXPOSED COUPLER MOLDED ARCHITECTURE FOR OPTICAL DEVICES;” U.S. Provisional Application Ser. No. 63/780,130, filed on Mar. 28, 2025, under Attorney Docket No. L0858.70112US04 and entitled “EXPOSED COUPLER MOLDED ARCHITECTURE FOR OPTICAL DEVICES;” U.S. Provisional Application Ser. No. 63/925,412, filed on Nov. 25, 2025, under Attorney Docket No. L0858.70112US05 and entitled “EXPOSED COUPLER MOLDED ARCHITECTURE FOR OPTICAL DEVICES,” each of which is hereby incorporated herein by reference in its entirety.

### BACKGROUND

As data communications systems continue to scale to meet ever-increasing bandwidth demands, the limitations of traditional copper data channels have become increasingly apparent. Signal attenuation, crosstalk, and electromagnetic interference pose significant challenges, which can be partially mitigated through techniques such as equalization, coding, and shielding. However, these approaches often require substantial power, complexity, and cable bulk, offering only modest improvements in reach and limited scalability. Optical communication has emerged as a promising successor to copper links, offering the potential to overcome these limitations.

### BRIEF SUMMARY

In some embodiments, a photonic device comprises a photonic integrated circuit (PIC) comprising a plurality of waveguides, an optical coupler array positioned near an edge of the PIC, the optical coupler array comprising a plurality of optical couplers, and a plurality of optical fibers. Each optical coupler of the optical coupler array defines an optical path coupling a respective waveguide of the plurality of waveguides to a respective optical fiber of the plurality of optical fibers. At least two optical couplers of the plurality of optical couplers are offset relative to each other.

In some embodiments, the at least two optical couplers are offset relative to each other along a longitudinal direction perpendicular to the edge of the PIC.

In some embodiments, each optical coupler of the at least two optical couplers comprises a collimating portion configured to collimate light along a direction perpendicular to a waveguide plane defined by the plurality of waveguides.

In some embodiments, the photonic device further comprises an encapsulant at least partially surrounding the optical coupler array, wherein the collimating portion reduces susceptibility of the photonic device to variations in a height of the encapsulant.

In some embodiments, each optical coupler of the at least two optical couplers is configured to emit light from a top surface of the PIC.

In some embodiments, the plurality of optical fibers are arranged in a staircase configuration.

In some embodiments, the at least two optical couplers are offset relative to each other along a vertical direction perpendicular to a waveguide plane defined by the plurality of waveguides.

In some embodiments, each optical coupler of the at least two optical couplers is configured to emit light from a side surface of the PIC.

In some embodiments, respective waveguides coupled to the at least two optical couplers terminate at a same distance from the edge of the PIC.

In some embodiments, the at least two optical couplers are offset relative to each other along both a vertical direction perpendicular to a waveguide plane defined by the plurality of waveguides and a longitudinal direction perpendicular to the edge of the PIC.

In some embodiments, each optical coupler of the at least two optical couplers is configured to emit light from a side surface of the PIC.

In some embodiments, adjacent optical fibers of the plurality of optical fibers are spaced apart by no more than 50 μm.

In some embodiments, each optical coupler of the at least two optical couplers comprises a first reflective portion and a second reflective portion, and a vertical separation between the first reflective portion and the second reflective portion differs between the at least two optical couplers.

In some embodiments, the optical coupler array comprises a monolithic body defining the plurality of optical couplers.

In some embodiments, each optical coupler of the plurality of optical couplers comprises a separate piece of material.

In some embodiments, a photonic device comprises a photonic integrated circuit (PIC) comprising a plurality of waveguides defining a waveguide plane, an optical coupler array positioned near an edge of the PIC, the optical coupler array comprising a plurality of optical couplers, and a plurality of optical fibers, each optical fiber optically coupled to a respective waveguide of the plurality of waveguides via a respective optical coupler of the plurality of optical couplers. The plurality of optical couplers are offset relative to each other in at least one of a first direction perpendicular to the waveguide plane or a second direction perpendicular to the edge of the PIC.

In some embodiments, the plurality of optical couplers are offset relative to each other in the second direction, and each optical coupler of the plurality of optical couplers is configured to emit light from a top surface of the PIC.

In some embodiments, the plurality of optical couplers are offset relative to each other in the first direction, and each optical coupler of the plurality of optical couplers is configured to emit light from a side surface of the PIC.

In some embodiments, the plurality of optical couplers are offset relative to each other in both the first direction and the second direction.

In some embodiments, the optical coupler array comprises a monolithic body defining the plurality of optical couplers.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1A illustrates a cross-sectional view of a device with a two-dimensional fiber array using top coupling, according to aspects of the present disclosure.

FIG. 1B illustrates a top view of the device of FIG. 1A, according to aspects of the present disclosure.

FIG. 2A illustrates an isometric view of a device with a two-dimensional fiber array using side coupling, according to aspects of the present disclosure.

FIG. 2B illustrates a top view of the device of FIG. 2A, according to aspects of the present disclosure.

FIG. 3A illustrates an isometric view of another device with a two-dimensional fiber array using side coupling, according to aspects of the present disclosure.

FIG. 3B illustrates a top view of the device of FIG. 3A, according to aspects of the present disclosure.

### DETAILED DESCRIPTION

Described herein are photonic devices with offset optical coupler configurations for high density fiber coupling. The photonic devices may include photonic integrated circuits (PICs) comprising a plurality of waveguides, optical coupler arrays positioned near an edge of the photonic integrated circuits, and pluralities of optical fibers. The optical coupler arrays include a plurality of optical couplers, where each optical coupler defines an optical path coupling a respective waveguide to a respective optical fiber. In some cases, at least two optical couplers of the plurality of optical couplers are offset relative to each other. The offset configuration of the optical couplers may enable two-dimensional (2D) stacking of the optical fibers, which may provide fiber array densities that are at least two times higher than the density achievable with a one-dimensional (1D) array of fibers.

The inventors have recognized and appreciated that 2D stacking of fibers can provide very high shoreline fiber density. A 1D fiber array may be limited by fiber diameter, with a pitch of approximately 127 μm, and in some cases possibly going down to approximately 80 μm pitch. A 2D fiber array, on the other hand, may provide fiber array densities that are at least twice that of the 1D array. For example, a 2D array of fibers may achieve pitch densities as small as approximately 10 μm.

The inventors have developed two distinct approaches to achieve a 2D fiber array configuration: top coupling and side coupling. In top coupling configurations, optical couplers may be offset relative to each other along the longitudinal direction (e.g., a direction perpendicular to the edge of the photonic integrated circuit), enabling fibers to be arranged in a staircase configuration above the photonic integrated circuit. In side coupling configurations, optical couplers may be offset relative to each other along the vertical direction (e.g., a direction perpendicular to the waveguide plane), enabling fibers to be arranged in a staggered configuration next to the photonic integrated circuit. In some cases, side coupling configurations may combine both vertical and longitudinal offsets, where optical couplers are offset relative to each other along both a direction perpendicular to the waveguide plane and a direction perpendicular to the edge of the photonic integrated circuit. These offset configurations may enable decreased fiber spacing, which may result in higher bandwidth density for the photonic device. The decreased fiber spacing achievable with 2D fiber arrays may allow for a greater number of optical connections within a given footprint compared to 1D fiber arrays.

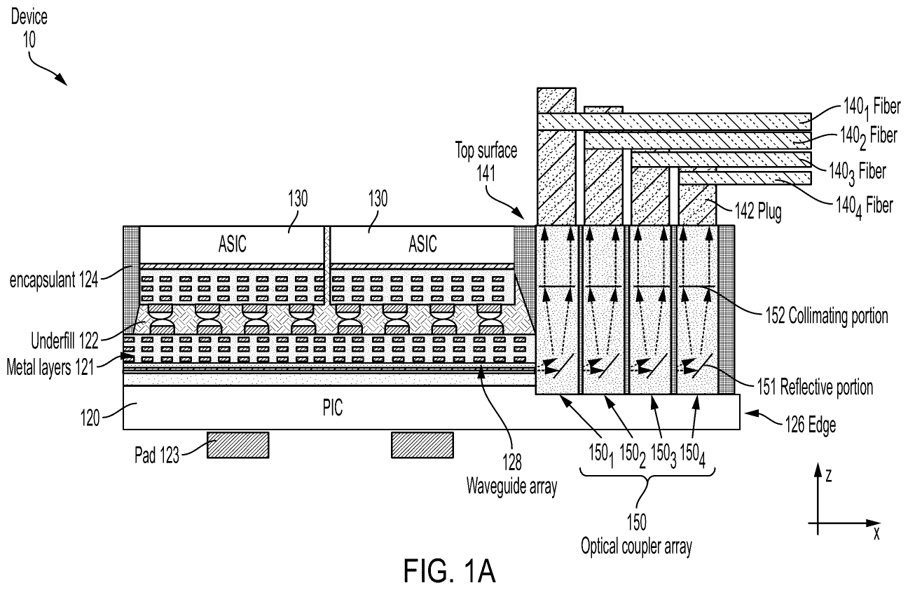

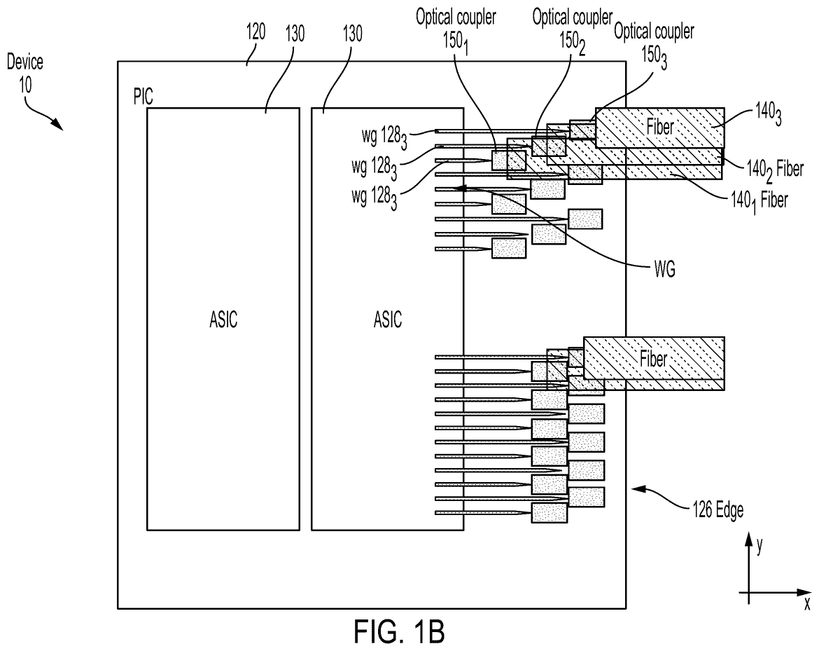

FIGS. 1A-1B illustrate an example of a device with top coupling. In top coupling configurations, light is extracted from the top surface of the device, a surface parallel to the plane of the photonic integrated circuit. Top coupling may enable fibers to be arranged in a staircase configuration above the photonic integrated circuit, accommodating offset optical paths from individual optical couplers.

Referring first to FIG. 1A, a device 10 includes a photonic integrated circuit (PIC) 120 comprising a waveguide array 128 formed within the photonic integrated circuit 120. The waveguides of the array define a waveguide plane that extends substantially parallel to the top surface of the photonic integrated circuit 120. The waveguide plane is oriented horizontally within the photonic integrated circuit 120, parallel to the xy plane as shown in FIG. 1A, with the waveguides extending along directions within this plane to route optical signals between various optical components.

The photonic integrated circuit 120 may be fabricated using silicon photonics technology, enabling integration of optical components on a silicon substrate. In some embodiments, the photonic integrated circuit 120 may include a silicon-on-insulator (SOI) substrate including a buried oxide layer that provides optical confinement for the waveguides. The photonic integrated circuit 120 may further include various optical components such as modulators, photodetectors, multiplexers, demultiplexers, and other passive or active optical elements integrated within the same substrate. The photonic integrated circuit 120 includes metal layers 121 disposed on an upper surface thereof. The metal layers 121 may facilitate electrical connections and signal routing within the device 10. The metal layers 121 may include multiple metallization levels interconnected by vias, providing electrical pathways between the photonic integrated circuit 120 and other components of the device 10. Pads 123 are positioned on a lower surface of the photonic integrated circuit 120. The pads 123 may provide electrical connection to external circuitry or components, such as a package substrate or printed circuit board.

Application-specific integrated circuits (ASICs) 130 are mounted above the photonic integrated circuit 120. The photonic integrated circuit 120 is electrically coupled to each application-specific integrated circuit 130. The application-specific integrated circuits 130 may include driver circuitry configured to provide electrical signals to modulators within the photonic integrated circuit 120. The application-specific integrated circuits 130 may also include transimpedance amplifiers configured to receive electrical signals from photodetectors within the photonic integrated circuit 120. In some embodiments, the application-specific integrated circuits 130 may include digital signal processing circuitry, serializer/deserializer (SerDes) circuitry, clock and data recovery circuitry, or other electronic components for processing data signals. In some embodiments, an application-specific integrated circuit 130 may comprise a graphics processing unit (GPU), a central processing unit (CPU), a high bandwidth memory (HBM) device, a network switch, a tensor processing unit (TPU), or other high-performance computing components. The application-specific integrated circuits 130 may be fabricated using complementary metal-oxide-semiconductor (CMOS) technology, enabling high-speed electronic processing capabilities. The application-specific integrated circuits 130 may be flip-chip bonded to the photonic integrated circuit 120, with solder bumps or copper pillars providing electrical and mechanical connections between the two circuits. Alternatively, the application-specific integrated circuits 130 may be hybrid-bonded to the photonic integrated circuit 120. An underfill 122 is disposed between the application-specific integrated circuits 130 and the metal layers 121 of the photonic integrated circuit 120. The underfill 122 may provide mechanical support and thermal management between the photonic integrated circuit 120 and the application-specific integrated circuits 130. The underfill 122 may comprise an epoxy-based material that fills the gap between the application-specific integrated circuits 130 and the photonic integrated circuit 120, providing stress relief and protecting the interconnections from environmental factors.

An encapsulant 124 surrounds the application-specific integrated circuits 130. In some embodiments, the encapsulant 124 may also at least partially surround the optical coupler array 150 (described in detail further below). The encapsulant 124 may provide mechanical protection and environmental sealing for the device 10. The encapsulant 124 may comprise a molded material, such as an epoxy molding compound, that encapsulates the assembly and provides structural support. The encapsulant 124 may be formed using a transfer molding process or other suitable encapsulation techniques. The encapsulant 124 may also provide thermal management by dissipating heat generated by the application-specific integrated circuits 130, photonic integrated circuit 120, and other active components within the device 10.

As further shown in FIG. 1A, an optical coupler array 150 including a plurality of optical couplers is positioned near an edge 126 of the photonic integrated circuit 120. The optical coupler array comprises optical couplers 150₁, 150₂, 150₃, and 150₄ in this example, although it may comprise more or fewer couplers in other examples. Each optical coupler of the optical coupler array 150 defines an optical path coupling a respective waveguide of the waveguide array 128 to a respective optical fiber of a plurality of optical fibers.

At least two optical couplers of the plurality of optical couplers 150 are offset relative to each other along the longitudinal direction (the x-axis, corresponding to the direction perpendicular to the plane defined by edge 126, the yz plane). Each optical coupler of the optical coupler array may be configured to emit light from the top surface 141 of device 10.

Each optical coupler 150 includes a reflective portion 151 and a collimating portion 152. The reflective portion 151 is configured to redirect light emitted by a waveguide of waveguide array 128 outside the xy plane. In some cases, the reflective portion 151 redirects light from a waveguide in an upward direction toward the corresponding optical fiber. The collimating portion 152 is configured to collimate light along the direction perpendicular to the waveguide plane. As used herein, a collimated beam (or collimated light) refers to a beam of light in which all rays are substantially parallel to each other and do not diverge or converge as the beam propagates. To achieve the collimation, collimating portion 152 may include optical elements such as lenses or curved transmissive surfaces that transform a diverging beam into a parallel beam. The degree of collimation may be characterized by the beam divergence angle, with a perfectly collimated beam having zero divergence. In practice, collimated beams may have small divergence angles, typically on the order of milliradians or less. Collimation is advantageous in this coupling scheme because it reduces sensitivity to alignment tolerances and variations in optical path length. For example, the collimating portion 152 may reduce susceptibility of the device 10 to variations in the height of the encapsulant 124 along the z-axis.

A plurality of fibers 140, including a first fiber 140₁, a second fiber 140₂, a third fiber 140₃, and a fourth fiber 140₄, are arranged above the device 10. The plurality of fibers 140 are arranged in a staircase configuration, wherein adjacent fibers are offset relative to each other along both a direction parallel to the z-axis (perpendicular to the waveguide plane) and a direction parallel to the x-axis (perpendicular to the edge 126), such that each successive fiber is positioned at a different height and at a different horizontal distance from the edge 126 of the photonic integrated circuit 120.

A plug 142 holds the plurality of fibers 140. The plug 142 is configured to hold and align the plurality of fibers 140 to the optical coupler array. The plug 142 positions the fibers 140 in the staircase arrangement to accommodate overlapping optical paths from individual optical signals. The staircase configuration of the plurality of fibers 140 may enable routing of the fibers 140 on top of each other, which may accommodate the offset arrangement of the optical couplers 150.

Referring to FIG. 1B, a top view of the device 10 shows a high density 2D array architecture for optical coupling. The device 10 includes the photonic integrated circuit 120 comprising a plurality of waveguides defining a waveguide plane. The plurality of waveguides includes waveguides (“wg”) 128₁, 128₂, and 128₃, that route optical signals toward an edge 126 of the photonic integrated circuit 120. An optical coupler array is positioned near the edge of the photonic integrated circuit 120. The optical coupler array comprises a plurality of optical couplers, including optical coupler 150₁, optical coupler 150₂, and optical coupler 150₃.

The plurality of optical couplers are offset relative to each other along the x-axis. This offset configuration is enabled by the waveguides 128₁, 128₂, and 128₃ having ends that terminate at different distances from the edge 126 of the photonic integrated circuit 120. Specifically, each waveguide of the plurality of waveguides extends a different length toward the edge 126, such that the termination points of the waveguides are staggered along the direction perpendicular to the edge 126. This staggered termination arrangement provides the necessary spatial separation to accommodate the offset positioning of the optical couplers 150. By terminating the waveguides at different distances from the edge 126, each optical coupler 150 can be positioned at a corresponding offset location without interference from adjacent optical couplers, thereby enabling the two-dimensional stacking of the optical fibers. The different termination distances of the waveguides allow for more efficient use of the available space for free space optics between the waveguide terminations and the plurality of optical couplers 150, which is critical for achieving the high density fiber coupling configurations described herein. Each optical coupler of the plurality of optical couplers 150 is configured to emit light from a top surface of the photonic integrated circuit 120.

In some cases, the optical coupler array may comprise a monolithic body defining the plurality of optical couplers. The monolithic body may be formed as a single, unitary piece of material, such as a molded optical polymer or glass, in which all of the optical couplers are integrally defined. Alternatively, the monolithic body may be made of silicon. This monolithic construction may provide advantages in terms of structural integrity, alignment stability, and manufacturing simplicity, as the relative positions of the optical couplers are fixed during the fabrication process and do not require individual alignment of separate components. The monolithic body may be fabricated using precision molding techniques, such as injection molding or compression molding, that enable accurate formation of the reflective portions 151 and collimating portions 152 within each optical coupler. In other cases, each optical coupler of the plurality of optical couplers may comprise a separate piece of material. In such configurations, the individual optical couplers may be separately fabricated and subsequently assembled into the optical coupler array. The use of separate pieces may enable replacement of individual optical couplers if needed, and allow for different optical coupler designs to be combined within the same array.

With continued reference to FIG. 1B, a plurality of optical fibers are arranged in a staircase configuration. The plurality of optical fibers includes fiber 140₁, fiber 140₂, and fiber 140₃. Each optical fiber is optically coupled to a respective waveguide of the plurality of waveguides via a respective optical coupler of the optical coupler array 150. The waveguide 128₁, 128₂, 128₃ extend in the photonic integrated circuit 120 toward the optical coupler array at the edge of the photonic integrated circuit 120.

The offset configuration of the plurality of optical couplers 150 enables the 2D staircase configuration of the plurality of optical fibers. The fiber array may be configured with 2 rows, 3 rows, 4 rows, or 4-5 rows in the 2D array configuration. As shown in FIG. 1B, a two-row configuration and a three-row configuration are illustrated as non-limiting examples. The 2D staircase configuration of the plurality of optical fibers may increase the number of optical connections compared to a 1D array arrangement.

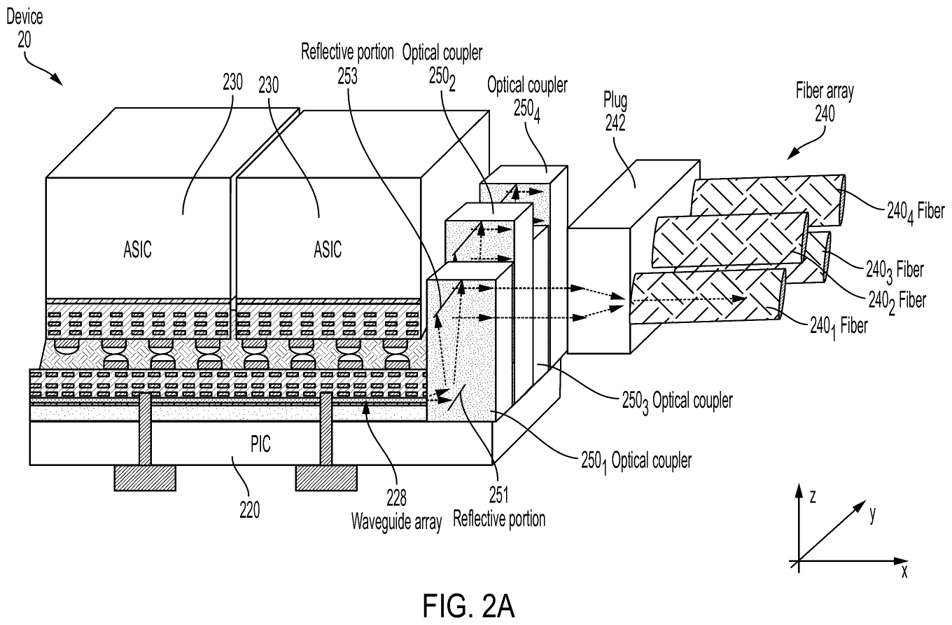

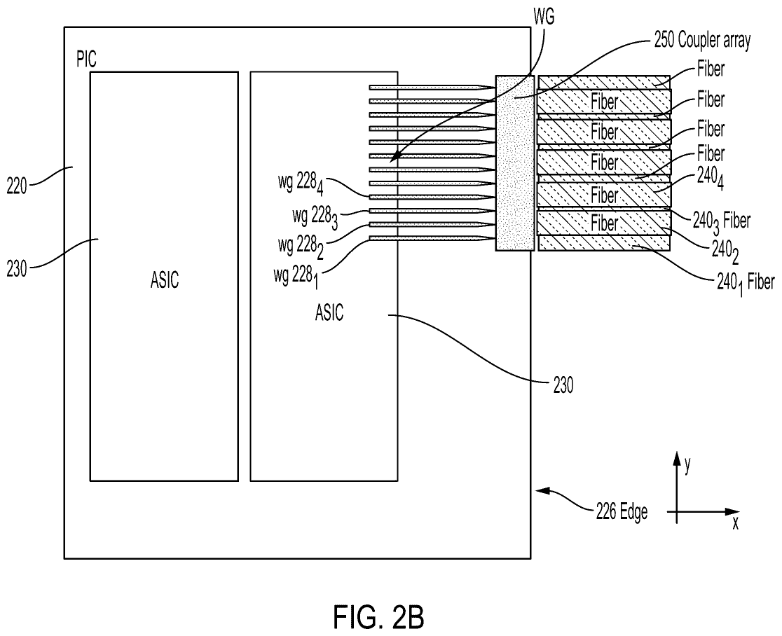

Referring to FIG. 2A, a device 20 is similar to the device 10 of FIGS. 1A-1B in that the device 20 includes a photonic integrated circuit 220, application specific integrated circuits 230, an optical coupler array 250, and a fiber array 240. However, the device 20 differs from the device 10 in that optical couplers of the device 20 emit light from a side surface rather than a top surface of the photonic integrated circuit. The device 20 illustrates a side coupling arrangement, unlike the vertical coupling arrangement of the device 10 shown in FIGS. 1A-1B.

A photonic integrated circuit 220 comprises a waveguide array 228 integrated within the photonic integrated circuit 220. The waveguide array 228 defines a waveguide plane within the photonic integrated circuit 220. As further shown in FIG. 2A, an optical coupler array is positioned near an edge 226 of the photonic integrated circuit 220. The optical coupler array comprises a plurality of optical couplers, including an optical coupler 250₁, an optical coupler 250₂, an optical coupler 250₃, and an optical coupler 250₄. The plurality of optical couplers are arranged in a staggered configuration. At least two optical couplers of the plurality of optical couplers 250 are offset relative to each other along a direction perpendicular to the waveguide plane defined by the waveguide array 228. For example, the optical couplers may extend in the vertical direction (z-axis) by different amounts. Each optical coupler of the at least two optical couplers is configured to emit light from a side surface of the photonic integrated circuit 220.

Each optical coupler 250 includes a reflective portion 251 and a reflective portion 253. The reflective portion 251 and the reflective portion 253 direct light between the waveguide array 228 and a plurality of fibers 240. The reflective portion 251 is positioned at a base of each optical coupler 250, proximate to the waveguide array 228, while the reflective portion 253 is positioned further up along the z-axis within each optical coupler structure. The offset arrangement of the plurality of optical couplers 250 may be achieved by varying the vertical separation between the reflective portion 251 and the reflective portion 253 in different optical couplers. Specifically, each optical coupler of the plurality of optical couplers 250 may have a different vertical distance between its respective reflective portion 251 and reflective portion 253, such that the reflective portions 253 of different optical couplers are positioned at different heights along the z-axis. For example, the optical coupler 250₁ may have a first vertical separation between its reflective portions 251 and 253, while the optical coupler 2502 may have a second, larger vertical separation between its reflective portions 251 and 253, positioning the reflective portion 253 of the optical coupler 250₂ at a greater height than the reflective portion 253 of the optical coupler 250₁. This variation in vertical separation enables each optical coupler 250 to direct light to a corresponding fiber positioned at a different height within the 2D fiber array, thereby accommodating the two-dimensional staggered arrangement of the plurality of fibers 240.

In some cases, the optical coupler array may comprise a monolithic body defining the plurality of optical couplers 250. The monolithic body may be fabricated using precision molding techniques, such as injection molding or compression molding, that enable accurate formation of the reflective portions 251 and 253 within each optical coupler 250. In other cases, each optical coupler of the plurality of optical couplers 250 may comprise a separate piece of material. In such configurations, the individual optical couplers 250 may be separately fabricated and subsequently assembled into the optical coupler array.

A plurality of fibers 240 are arranged in a two-dimensional array extending from the side surface of the photonic integrated circuit 220. The plurality of fibers 240 includes a first fiber 240₁, a second fiber 240₂, a third fiber 240₃, and a fourth fiber 240₄. At least two of the plurality of fibers 240 are positioned at different heights along the z-axis, corresponding to the staggered arrangement of the plurality of optical couplers 250. Specifically, each fiber of the plurality of fibers is positioned at a height that corresponds to the height of the reflective portion 253 of its respective optical coupler 250. For example, the first fiber 240₁ may be positioned at a first height corresponding to the reflective portion 253 of the optical coupler 250₁, while the second fiber 240₂ may be positioned at a second, greater height corresponding to the reflective portion 253 of the optical coupler 250₂, which has a larger vertical separation between its reflective portions 251 and 253. This arrangement enables each fiber 240 to receive light from its corresponding optical coupler at the appropriate height within the 2D fiber array. A plug 242 secures and aligns the plurality of fibers 240 with the plurality of optical couplers 250. Each optical coupler 250 of the optical coupler array defines an optical path coupling a respective waveguide of the waveguide array 228 to a respective optical fiber of the plurality of fibers 240. Light paths travel from the waveguide array 228 through the reflective portions 251 and 253 of the optical couplers 250 and into the respective fibers 240.

The side coupling configuration of the device 20 may achieve a fiber pitch of approximately 50 μm or less. With a 2-row configuration, adjacent optical fibers of the plurality of fibers 240 may be spaced apart by no more than 25 μm, enabling approximately 25 μm pitch. A 4-row 2D array configuration may achieve a pitch of approximately 12.5 μm. The side coupling configuration with the plurality of optical couplers 250 at different heights enables the 2D fiber array to achieve high fiber array densities while maintaining compatibility with existing fiber routing schemes on boards or racks.

Referring to FIG. 2B, a top view of the device 20 shows the photonic integrated circuit 220 and the fiber array configuration. The waveguide array 228 extends in the photonic integrated circuit 220 toward a coupler array positioned near an edge 226 of the photonic integrated circuit 220. The waveguide array 228 comprises a plurality of waveguides arranged in a parallel configuration. The waveguide array 228 includes a first waveguide 228₁, a second waveguide 228₂, a third waveguide 228₃, and a fourth waveguide 228₄. The first waveguide 228₁, the second waveguide 228₂, the third waveguide 228₃, and the fourth waveguide 228₄ terminate at the coupler array positioned near the edge of the photonic integrated circuit 220.

As further shown in FIG. 2B, a fiber array is positioned adjacent to the coupler array. The fiber array includes the plurality of fibers arranged in a two-dimensional configuration. The fiber array includes the first fiber 240₁, the second fiber 240₂, the third fiber 240₃, and the fourth fiber 240₄. The first fiber 240₁ is optically coupled to the first waveguide 228₁ through the coupler array. The second fiber 240₂ is optically coupled to the second waveguide 228₂ through the coupler array. The third fiber 240₃ is optically coupled to the third waveguide 228₃ through the coupler array. The fourth fiber 240₄ is optically coupled to the fourth waveguide 228₄ through the coupler array. The two-dimensional arrangement of the plurality of fibers 240 enables a higher fiber density compared to a one-dimensional array configuration.

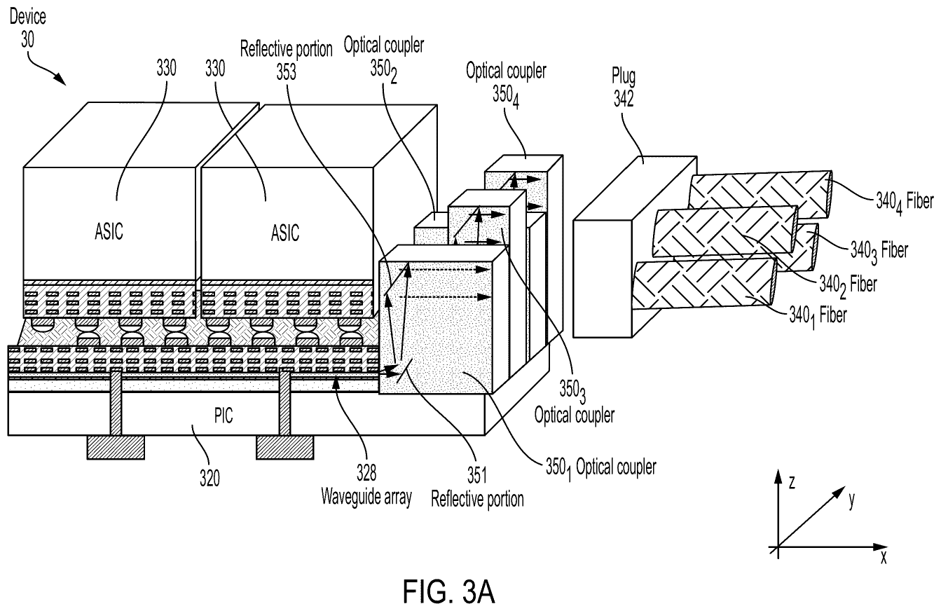

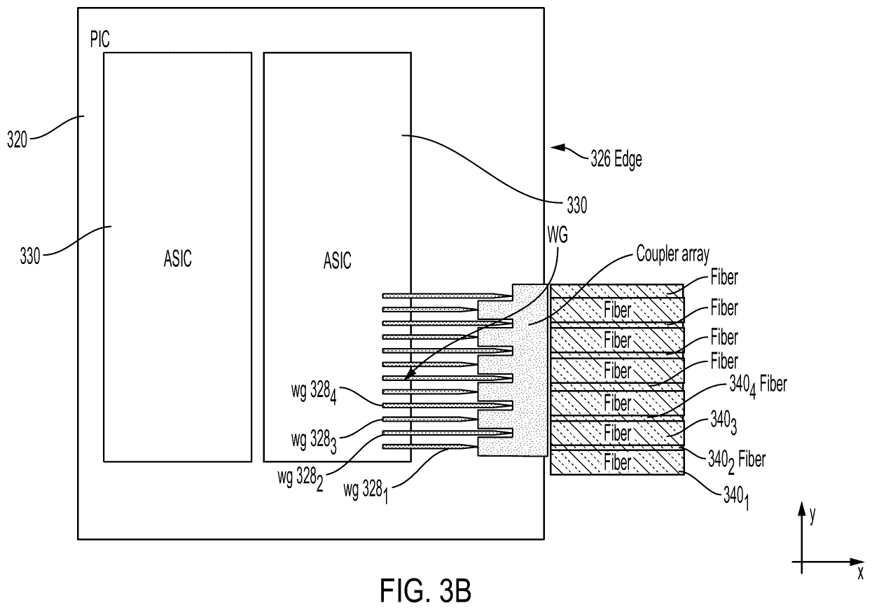

Referring to FIG. 3A, a device 30 is similar to the device 20 of FIGS. 2A-2B in that the device 30 uses side coupling with optical couplers of different heights. However, the device 30 differs from the device 20 in that waveguides of the device 30 terminate at different distances from an edge 326 of a photonic integrated circuit, allowing for more efficient use of available space for free space optics. The device 30 includes a PIC 320 comprising a waveguide array 328 that extends from the PIC 320 toward an optical coupling region. The waveguide 328 and other waveguides of the plurality of waveguides define a waveguide plane within the PIC 320.

Multiple ASICs 330 are mounted on top of the PIC 320. The ASICs 330 are positioned adjacent to each other on the PIC 320. The PIC 320 includes metal layers and interconnects that facilitate electrical connections between the PIC 320 and the ASICs 330.

As further shown in FIG. 3A, an optical coupler array is positioned near an edge 326 of the PIC 320. The optical coupler array comprises a plurality of optical couplers, including an optical coupler 350₁, an optical coupler 350₂, an optical coupler 350₃, and an optical coupler 350₄. At least two optical couplers of the plurality of optical couplers 350 are offset relative to each other along both a direction parallel to the x-axis and a direction parallel to the z-axis.

Each optical coupler 350 includes a reflective portion 351 and a reflective portion 353. The reflective portion 351 is positioned at a lower region of the optical coupling assembly. The reflective portion 353 is positioned at an upper region of the optical coupling assembly. The reflective portion 351 and the reflective portion 353 direct optical signals between the waveguide 328 and a plurality of fibers 340.

The offset arrangement of the plurality of optical couplers 350 along the z-axis may be similar to the offset arrangement described with reference to FIG. 2A, where different optical couplers have different vertical separations between their respective reflective portions. For example, the optical coupler 350₁ may have a first vertical separation between its reflective portion 351 and reflective portion 353, while the optical coupler 350₂ may have a second, larger vertical separation between its reflective portions 351 and 353, positioning the reflective portion 353 of the optical coupler 350₂ at a greater height than the reflective portion 353 of the optical coupler 3501. This variation in vertical separation enables each optical coupler 350 to direct light to a corresponding fiber 340 positioned at a different height within the 2D fiber array.

The offset arrangement of the plurality of optical couplers 350 along the x-axis may be achieved by terminating the waveguides at different distances from the edge 326 of the PIC 320 and by positioning the respective optical couplers at different distances from edge 326. Specifically, each waveguide of the plurality of waveguides extends a different length toward the edge 326, such that the termination points of the waveguides are staggered along the direction perpendicular to the edge 326. For example, a first waveguide may terminate at a first distance from the edge 326, while a second waveguide may terminate at a second, shorter distance from the edge 326. This staggered termination arrangement provides the spatial separation to accommodate the offset positioning of the optical couplers 350 along the x-axis. By terminating the waveguides at different distances from the edge 326, each optical coupler 350 can be positioned at a corresponding offset location without interference from adjacent optical couplers. The different termination distances of the waveguides allow for more efficient use of the available space for free space optics between the waveguide terminations and the plurality of optical couplers 350.

In some cases, each optical coupler of the plurality of optical couplers 350 may comprise a separate piece of material. In other cases, the optical coupler array may comprise a monolithic body defining the plurality of optical couplers 350.

A plug 342 is positioned adjacent to the plurality of optical couplers 350. The plug 342 serves to interface with a fiber array. A plurality of fibers 340 extend from the plug 342. The plurality of fibers 340 includes a fiber 340₁, a fiber 340₂, a fiber 340₃, and a fiber 340₄. The plurality of fibers 340 are arranged in a 2D array configuration. The plug 342 secures and aligns the plurality of fibers 340 with the plurality of optical couplers 350. Each optical coupler 350 of the optical coupler array defines an optical path coupling a respective waveguide of the plurality of waveguides to a respective optical fiber of the plurality of fibers 340.

The optical coupler array may achieve pitch densities as small as approximately 10 um when using a 4-5 row 2D array configuration, where the coupler optics is the source of size limitations. The side coupling configuration with the plurality of optical couplers 350 at different heights and with waveguides terminating at different distances from the edge enables the 2D fiber array to achieve high fiber array densities. The side connection of the plurality of fibers 340 is in-line with existing fiber routing schemes on boards or racks.

Referring to FIG. 3B, a top view of the device 30 shows the PIC 320 and the fiber array configuration. A waveguide array extends toward a coupler array positioned at an edge of the PIC 320. The waveguide array comprises a plurality of waveguides that terminate at different distances from the edge of the PIC 320. The waveguide array includes a first waveguide 328₁, a second waveguide 328₁, a third waveguide 328₃, and a fourth waveguide 328₄. The first waveguide 328₁ extends furthest toward the edge of the PIC 320. The fourth waveguide 328₄terminates at a shorter distance from the edge of the PIC 320 compared to the first waveguide 328₁. The second waveguide 328₂ and the third waveguide 328₃ terminate at intermediate distances between the first waveguide 328₁ and the fourth waveguide 328₄. The staggered termination distances of the first waveguide 328₁, the second waveguide 328₂, the third waveguide 328₃, and the fourth waveguide 328₄ allow for more efficient use of the available space for free space optics.

As further shown in FIG. 3B, a fiber array is coupled to the coupler array and is arranged in a 2D configuration. The fiber array includes a first fiber 340₁, a second fiber 340₂, a third fiber 340₃, and a fourth fiber 340₄. The first fiber 340₁ is optically coupled to the first waveguide 328₁ through the coupler array. The second fiber 340₂ is optically coupled to the second waveguide 328₂ through the coupler array. The third fiber 340₃ is optically coupled to the third waveguide 328₃ through the coupler array. The fourth fiber 340₄ is optically coupled to the fourth waveguide 328₄ through the coupler array. The 2D configuration of the first fiber 340₁, the second fiber 340₂, the third fiber 340₃, and the fourth fiber 340₄ may provide high fiber array density through 2D staggered arrangements.

While the implementations illustrated herein use reflective portions 151 (FIGS. 1A), 251 (FIG. 2A), and 351 (FIG. 3A), some embodiments of the PICs may include one or more grating couplers to couple light into and out from the waveguides of the PIC. A grating coupler may be optically coupled to a waveguide and configured to emit light received from the waveguide outside the waveguide plane, whether in the vertical direction or at a slight angle relative to the z-axis. In embodiments using grating couplers, the reflective portion (such as reflective portion 151) may be omitted since the grating coupler directly emits light outside the waveguide plane. In top coupling configurations, such as those illustrated in FIG. 1A, the optical coupler array may be configured to collimate light emitted through the grating couplers and direct the collimated light outside the top surface of the PIC toward the fiber array. In side coupling configurations, such as those illustrated in FIGS. 2A and 3A, the optical coupler array may include a reflective portion configured to steer light emitted from the grating coupler toward the side of the package and into the fiber array. In some embodiments, the optical coupler array may include both a collimating portion and a reflective portion to collimate and redirect light emitted by the grating couplers toward the plurality of optical fibers.

In some embodiments, the plurality of optical fibers described herein may include various fiber types depending on the application requirements. The fibers may be single-mode fiber, multimode fiber, polarization-maintaining fiber, or hollow-core fiber. Single-mode fibers may be used in applications requiring long-distance transmission with minimal signal degradation. Multimode fibers may be suitable for shorter-distance, high-bandwidth applications. Polarization-maintaining fibers may be employed in applications where preserving the polarization state of light is desired. Hollow-core fibers may offer advantages such as reduced latency and lower nonlinear effects for certain applications.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

As used herein, terms such as “above,” “below,” “over,” “under,” “adjacent,” “upper,” “top,” “lower,” “bottom,” “vertical,” “horizontal,” “lateral,” and similar positional or directional descriptors are used solely to describe the relative arrangement and orientation of features as illustrated in the drawings and are not intended to be limiting. Such terms do not require any particular orientation of the device in use, manufacture, or operation, and the described features may be oriented in any direction without departing from the scope of the present disclosure. Moreover, these terms are not intended to imply any absolute position, gravitational reference, or fixed spatial relationship, and components described as being positioned using positional or directional descriptors may be arranged in different relative positions, including inverted, rotated, or otherwise reoriented configurations, while still performing the same function in substantially the same way to achieve substantially the same result.

What is claimed is:

1. A photonic device, comprising:
a photonic integrated circuit (PIC) comprising a plurality of waveguides;
an optical coupler array positioned near an edge of the PIC, the optical coupler array comprising a plurality of optical couplers; and
a plurality of optical fibers,
wherein each optical coupler of the optical coupler array defines an optical path coupling a respective waveguide of the plurality of waveguides to a respective optical fiber of the plurality of optical fibers, and
wherein at least two optical couplers of the plurality of optical couplers are offset relative to each other.

2. The photonic device of claim 1, wherein the at least two optical couplers are offset relative to each other along a longitudinal direction perpendicular to the edge of the PIC.

3. The photonic device of claim 2, wherein each optical coupler of the at least two optical couplers comprises a collimating portion configured to collimate light along a direction perpendicular to a waveguide plane defined by the plurality of waveguides.

4. The photonic device of claim 3, further comprising an encapsulant at least partially surrounding the optical coupler array.

5. The photonic device of claim 2, wherein each optical coupler of the at least two optical couplers is configured to emit light from a top surface of the PIC.

6. The photonic device of claim 5, wherein the plurality of optical fibers are arranged in a staircase configuration.

7. The photonic device of claim 1, wherein the at least two optical couplers are offset relative to each other along a vertical direction perpendicular to a waveguide plane defined by the plurality of waveguides.

8. The photonic device of claim 7, wherein each optical coupler of the at least two optical couplers comprises a first reflective portion and a second reflective portion, and wherein a vertical separation between the first reflective portion and the second reflective portion differs between the at least two optical couplers.

9. The photonic device of claim 7, wherein each optical coupler of the at least two optical couplers is configured to emit light from a side surface of the PIC.

10. The photonic device of claim 9, wherein respective waveguides coupled to the at least two optical couplers terminate at a same distance from the edge of the PIC.

11. The photonic device of claim 1, wherein the at least two optical couplers are offset relative to each other along both a vertical direction perpendicular to a waveguide plane defined by the plurality of waveguides and a longitudinal direction perpendicular to the edge of the PIC.

12. The photonic device of claim 11, wherein each optical coupler of the at least two optical couplers is configured to emit light from a side surface of the PIC.

13. The photonic device of claim 1, wherein adjacent optical fibers of the plurality of optical fibers are spaced apart by no more than 50 μm.

14. The photonic device of claim 1, wherein the optical coupler array comprises a monolithic body defining the plurality of optical couplers.

15. The photonic device of claim 1, wherein each optical coupler of the plurality of optical couplers comprises a separate piece of material.

16. A photonic device, comprising:
a photonic integrated circuit (PIC) comprising a plurality of waveguides defining a waveguide plane;
an optical coupler array positioned near an edge of the PIC, the optical coupler array comprising a plurality of optical couplers; and
a plurality of optical fibers, each optical fiber optically coupled to a respective waveguide of the plurality of waveguides via a respective optical coupler of the plurality of optical couplers,
wherein the plurality of optical couplers are offset relative to each other in at least one of a first direction perpendicular to the waveguide plane or a second direction perpendicular to the edge of the PIC.

17. The photonic device of claim 16, wherein the plurality of optical couplers are offset relative to each other in the second direction, and wherein each optical coupler of the plurality of optical couplers is configured to emit light from a top surface of the PIC.

18. The photonic device of claim 16, wherein the plurality of optical couplers are offset relative to each other in the first direction, and wherein each optical coupler of the plurality of optical couplers is configured to emit light from a side surface of the PIC.

19. The photonic device of claim 16, wherein the plurality of optical couplers are offset relative to each other in both the first direction and the second direction.

20. The photonic device of claim 16, wherein the optical coupler array comprises a monolithic body defining the plurality of optical couplers.
